(19) United States
(12) Patent Application Publication
(10) Pub. No.: US 2002/0126137 A1
(43) Pub. Date: Sep. 12, 2002

(54) Data display device

(76) Inventor: Frederick G. Kaestner JR., Crestwood, KY (US)

Correspondence Address: JAMES C. EAVES JR., GREENEBAUM DOLL & MCDONALD PLLC, 3300 NATIONAL CITY TOWER, 101 SOUTH FIFTH STREET, LOUISVILLE, KY, 40202, US

(21) Appl. No.: 10/092,151

(22) Filed: Mar. 6, 2002

Related U.S. Application Data
(60) Provisional application No. 60/273,782, filed on Mar. 6, 2001.

(51) Int. Cl. G09G 5/00

(52) U.S. Cl. 345/619

(57) ABSTRACT

An electronic system 10 for acquiring, storing, and displaying data includes a control unit 20 having a processor 30, a plurality of sensor inputs 38, a plurality of sensors 120, and a user configurable visual display 60. The invention 10 also includes a plurality of push buttons for use as an operator interface to allow a user to configure a plurality of viewing and sensing parameters and to view historical data on demand.

### BACKGROUND OF THE INVENTION

This application claims the benefit of copending U.S. Provisional Application Serial No. 60/273,782, filed Mar. 6, 2001, and entitled “Data Display Device”.

(a) Field of the Invention

The present invention relates in general to a device for acquiring, storing, and displaying data and more particularly to a programmable electronic data display device that provides a graphical representation of a plurality of data inputs as a function of time.

(b) Description of the Prior Art

In many process control engineering applications an historical record of prior data samples is desirable for A5 conducting analysis of a variable in a process, for example, a temperature, pressure, weight, flow rate, or level. The prior art provides numerous devices for recording historical data such as pen recorders for circular charts and strip chart recorders. A circular chart displays all information on a single chart, while strip chart recorders typically provide recorded data on a take-up roll. Both pen recorders and strip recorders can only display data as it is collected. A user simply does not have the ability to view data displayed with alternate time frames or limits.

Alternatively, data may be recorded electronically into a device such as a datalogger where it can be retrieved at a later time by downloading the data into a separate electronic device. This method is time-consuming, often requires technical expertise, and obviates the ability to quickly analyze and review any collected data to respond to changing conditions.

Such prior art devices are often costly and difficult to maintain and operate, requiring a threshold level of technical expertise often unavailable in a factory floor environment.

### SUMMARY OF THE INVENTION

The instant invention provides a novel device for recording and displaying data. The invention allows a user the ability to instantly view, scale, and interpret temporal data. The instant invention is compact, self-contained, is capable of being powered by batteries contained within a control unit, and is configurable for a wide variety of applications.

The data display device provides an assembly for collecting, storing, and displaying variable data comprising a plurality of remote data sensors, a conventional micro-controller or processor for processing received data, on board random access memory to store received data(RAM), a real time clock for data annotation, a graphical display, and a plurality of buttons to allow user programming of configurable parameters.

Furthermore, the instant invention employs a graphical menu system whereby a user may configure the collection, storage, and display of data with minimal expertise. The user can view stored data in a plurality of configurable formats, changing the period, amplitude and type of graphical display. Additionally, the instant invention provides the ability to view data immediately and respond accordingly. The instant invention may further comprise at least one alarm output or alarm relay output that is triggered according to user configurable parameters.

The present invention is ideally suited for remotely monitoring a physical variable such as temperature or pressure, and providing a user with a configurable graphical representation of the variable, thereby allowing for instantaneous data analysis. Additionally, a user may be alerted to a data point that exceeds an alarm threshold, allowing corrective action to be taken immediately. For example, in a food service application, the invention may be employed to continuously monitor freezer or cooler temperatures and alarm an operator when a temperature in the freezer approaches a level that would lead to spoilage. This provides the ability to closely monitor historical freezer data and correct potential mechanical problems prior to failure.

Therefore it is one object of the invention to provide a data collection, recording and display device.

It is a further object of the invention to provide a user configurable data display device.

It is a further object of the invention to provide a data display device capable of accepting data sample signals from multiple sensor sources.

It is a further object of the invention to provide a data display device capable of graphically representing historical data upon demand.

It is a further object of the invention to allow a user to configure a plurality of display parameters for data viewing.

Other features, advantages, and objects of the invention will be apparent from the detailed description of the preferred embodiments below taken in conjunction with the accompanying drawing figures.

### BRIEF DESCRIPTION OF THE DRAWINGS

FIG. 1 is a block diagram of the instant invention.

FIG. 2 is a block diagram of a power subsystem in accordance with the instant invention.

FIG. 3 is a process flowchart in accordance with the instant invention.

FIG. 4 is a process flowchart in accordance with the instant invention.

FIG. 5 is a process flowchart in accordance with the instant invention.

FIG. 6 is a process flowchart in accordance with the instant invention.

FIG. 7 is a process flowchart in accordance with the instant invention.

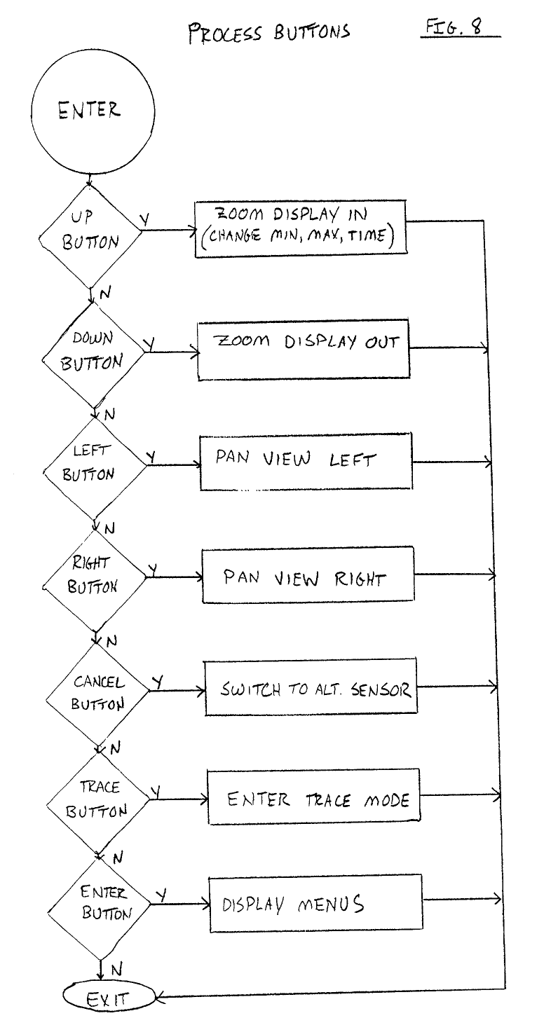

FIG. 5 is a process flowchart in accordance with the instant invention.

FIG. 9 is a process flowchart in accordance with the instant invention.

FIG. 10 is a process flowchart in accordance with the instant invention.

FIG. 11 is an example of a data display in accordance with an embodiment of the instant invention.

FIG. 12 is an example of a data display in accordance with an embodiment of the instant invention.

### DETAILED DESCRIPTION OF THE PREFERRED EMBODIMENT

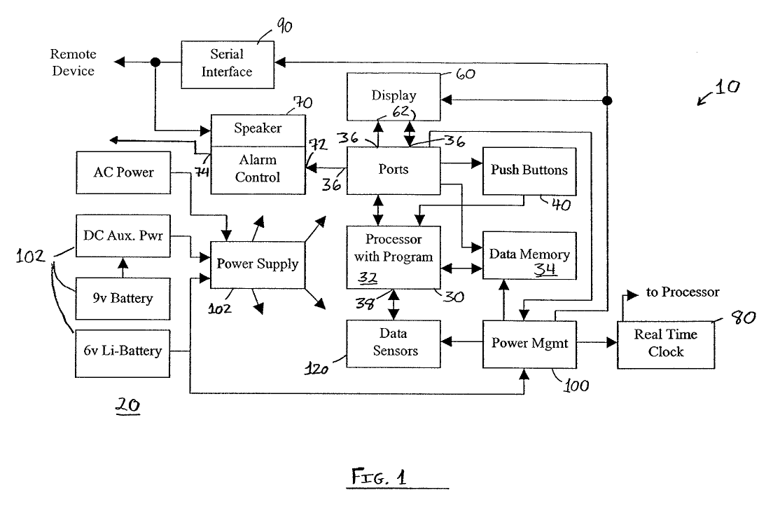

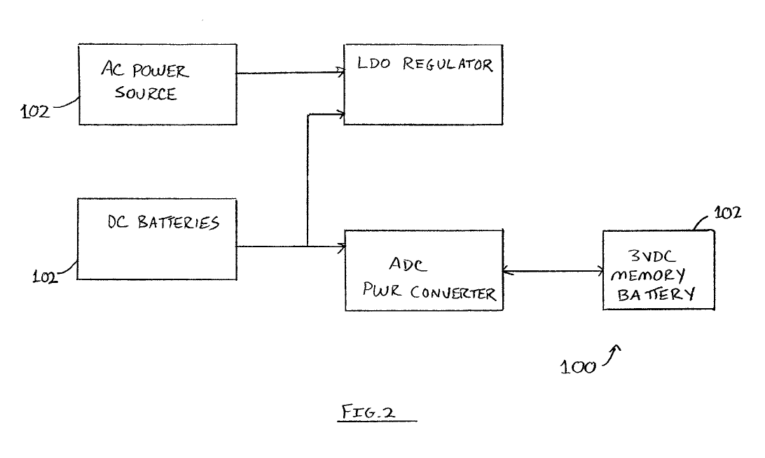

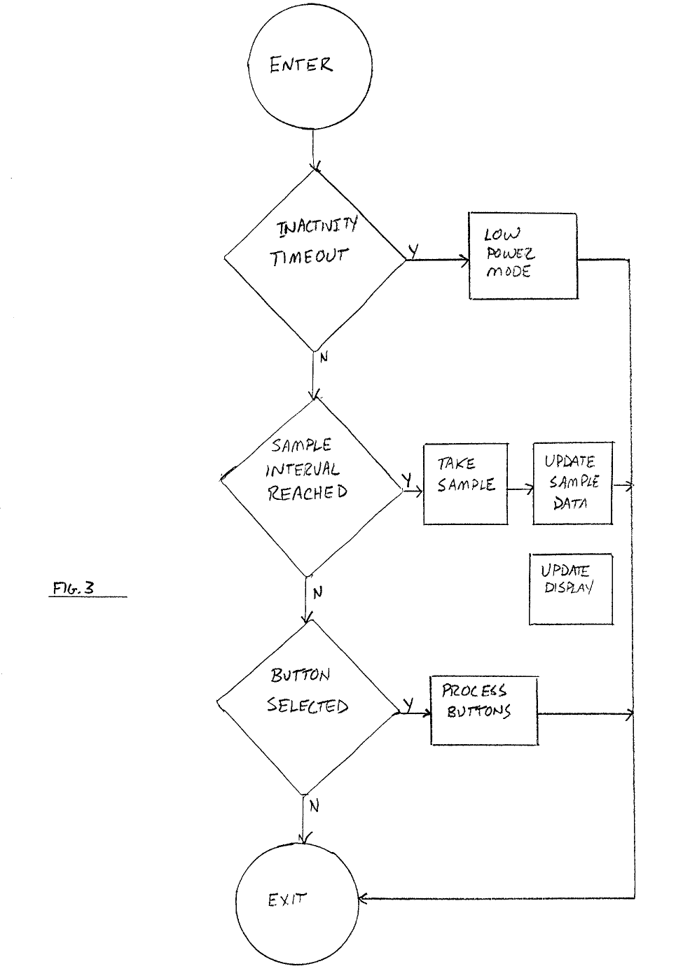

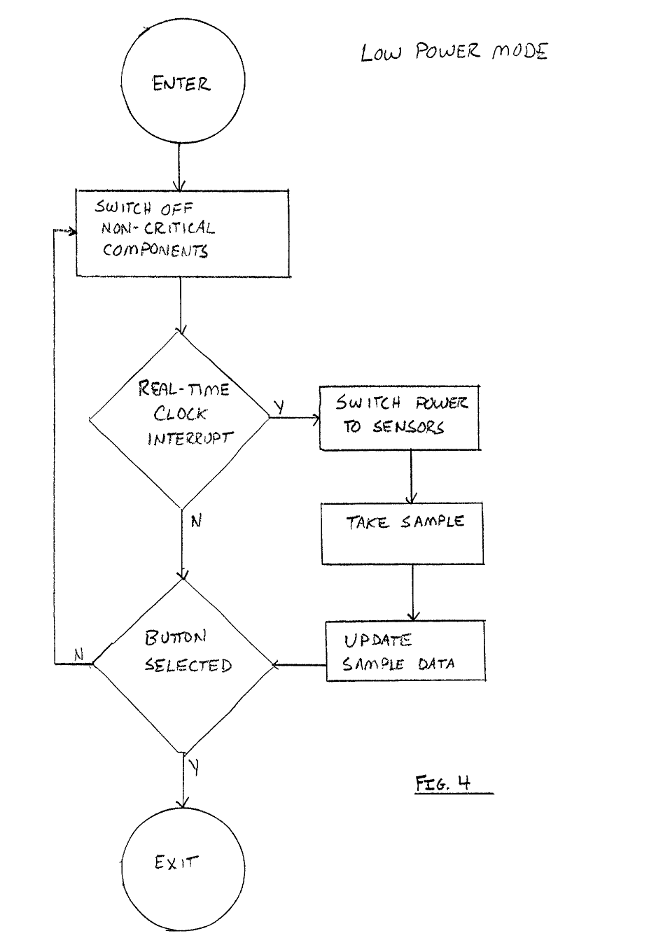

Referring now to drawing FIGS. 1 and 2, and in accordance with a preferred constructed embodiment of the instant invention, an electronic device 10 for acquiring, displaying, and storing data comprises a control unit 20 and a plurality of data sensors 120 coupled thereto for measuring a physical variable and transmitting a signal representative of the is physical variable to the control unit 20. The data signals are read by the control unit 20 at user-configurable time intervals, then stored and displayed by the control unit 20 as discussed in detail below.

The control unit 20 comprises a conventional processor 30 capable of executing a software program, as is well known to one of ordinary skill in the art. It will be recognized by one of ordinary skill in the art that the software program may be written using any number of commercially available software instruction sets, without departing from the scope of the instant invention. The processor 30 has an associated read-only memory 32 for storing the software program and random access memory 34 for storing data samples therein. The processor 30 further has a plurality of output channels 36 for sending data to a display as discussed in greater detail below, and providing an alarm output that may be configured to activate an output channel 36 in the event that a data sample exceeds a user-configured value limit.

The control unit 10 further has a plurality of sensor inputs 38 electrically coupled to the plurality of data sensors to accept electrical data signals therefrom. The sensor 120 data signals may be digital or analog as a particular application requires. In the embodiment of the instant invention wherein an analog signal is supplied by the sensor 120, a conventional A/D converter may be employed to converter the analog data signal into a digital signal. The analog signal supplied may be resistance, current, voltage, or frequency, as is well known to one of ordinary skill in the art. As one example of a sensor 120 that provides an electrical signal representative of a physical parameter, a commercially available TMP04 solid state temperature sensor manufacture by Analog Devices is well suited for use in the present invention 10.

The control unit 20 further comprises a plurality of push buttons 40 as an operator interface. The push buttons 40 are electrically coupled to the processor 30 and are used to allow an operator or user to configure a plurality of user configurable parameters such as data sample intervals, display configuration parameters, data display intervals, high and low alarm values, and sensor types by selecting from various menu options. Each push button 40 is electrically connected to the processor 30 which reads a signal from each push button 40 and responds according to logic present in the processor resident software program.

The control unit 20 additionally has a visual display 60 for displaying a graphical representation of historical data values and the various menu options that may be accessed using the push buttons 40. One of many commercially available displays 60 may be employed, but in one embodiment of the instant invention, a monochrome liquid crystal display, for example a conventional 240×128 pixel display having an on-board processor and associated driver software, and having a plurality of data inputs 62 electrically coupled to at least one processor output channel 36.

When a data signal is sampled, it is received by the processor 30 and stored in memory 34, then sent via the data output channel 36 to one of the data inputs 62 of the display 60. The signal is represented as a lighted pixel or pixels on the display 60, depending on the relative value of the signal being displayed. Once a new data sample is received via the aim output channel 36, the preceding sample's display representation is scrolled one dot or column to the left on the display 60.

This sample display procedure is repeated until the portion of the display 60 reserved for data representation is full, i.e., no empty columns remain.

Once the display 60 is filled with sample values, each column is thence used to represent a pair of sample values, one high and one low. This is graphically represented by a line comprised of pixels that runs vertically between the two sample values, beginning at the low value and ending at the high value. Similarly, once the display 60 is again filled with sample pairs, each column employs a solid line to represent four data sample values, the top of the line sample value being the largest value sample, and the bottom of the line representing the lowest sample value. This feature of the instant invention 10 allows the display 60 to show a larger number of sample values than conventional data displays.

Additionally, the control unit 20 can store in memory 34 a plurality of data sample sets gathered from the plurality of sensors 120. Using the push buttons 40 a user may toggle between the plurality of data sets to select the sensor 120 data they wish to view on the display 60. Furthermore, the user can select the period of time they wish to view and the display data high and low values (the scale) on the display 60 by configuring the display 60 using the push buttons and associated menus.

The control unit 20 further comprises a conventional speaker 70 having an input 72 connected to a processor alarm output that sounds an audible alarm when a data sample exceeds a predetermined high or low limit. In one embodiment of the invention, the high and low limits may be selected by an operator using the push buttons 40. The control unit 20 also has a real-time clock 80 to allow for accurate timing of intervals between data samples and time-stamping each data sample. Each data sample value is stored with an associated time value so that reliable historical data may be readily accessed.

A communications port 90 is also provided as a part of the control unit 20 to enable a user to transmit and receive serial data to and from a remote device, for example a personal computer or digital assistant. A wide variety of conventional communications protocols may be employed, for example RS232, or Ethernet communications. This feature of the invention 10 allows a user to export a set of data samples from memory 34 to a remote device for further processing.

In an alternative embodiment of the instant invention, the control unit further comprises at least one alarm output 74 for triggering a remote alarm. The alarm output 74 may be digital, analog, or a relay contact closure, as is well known to one of ordinary skill in the art.

In another embodiment of the instant invention as shown in FIG. 2, the control unit 20 further comprises a power management system 100 that allows the control unit 20 to operate on minimum power until a data sample must be taken, whereupon the power management system 100 switches power to the sensors 120. The required data sample is then taken and stored in memory 34. If no push button 40 has been selected, the power management system 100 continues to operate the control unit 20 and all it's associated components on minimum power until the next sample, or a user input occurs, whichever comes first. This feature permits the control unit 20 to consume an absolute minimum of power, thereby allowing the use of dc batteries to power the device if necessary.

It should be noted that the instant invention 10 may employ a variety of power sources 102, for example a 12 volt dc source supplied from a wall transformer and a dc battery backup, 9 volt dc batteries, or 6 volt dc batteries. As an example, the power management system 100 of the instant invention comprises a conventional means for accepting available 110 volt power, for example a conventional power cord, and an AC to DC power converter for rectifying the AC power to 9 volts direct current power. A low dropout (LDO) voltage regulator, for example a commercially available TPS76550 chipset, provides a very low power drain source to the various control unit 20 components.

In an alternative embodiment of the instant invention, a plurality of direct current batteries 102 are provided as a power source. In this embodiment of the instant invention the LDO regulator allows for much lower power usage, thereby extending the life of the batteries.

The power management system may further comprise a memory battery having an analog-to-digital converter (A/D) that is used to monitor the voltage level at the battery. Carefully monitoring this voltage allows the memory battery to send a signal to the processor 30 representative of the remaining battery life, which is then sent to the graphical display 60.

The power management system 100 further comprises a power management device, for example a commercially available TPS1120P-channel MOSFET, for distribution and management of power throughout the device. The power management device is advantageous in the instant invention 10 as it allows for partial power down control of circuits and devices that are unnecessary for data acquisition.

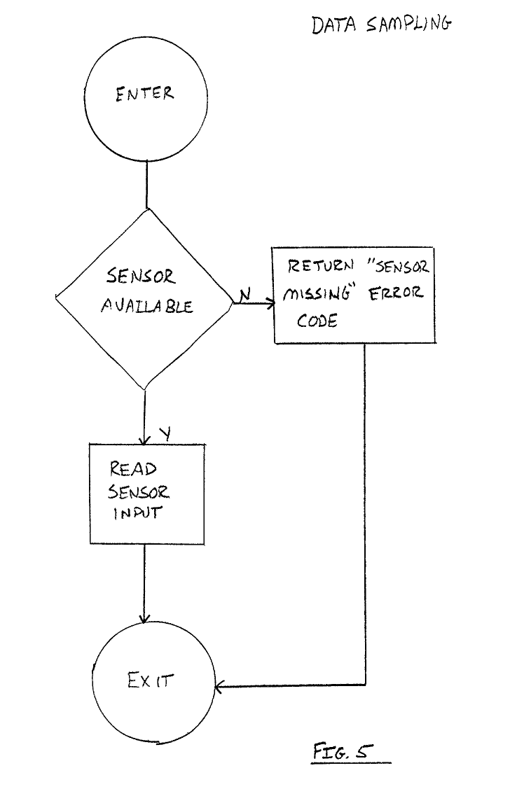

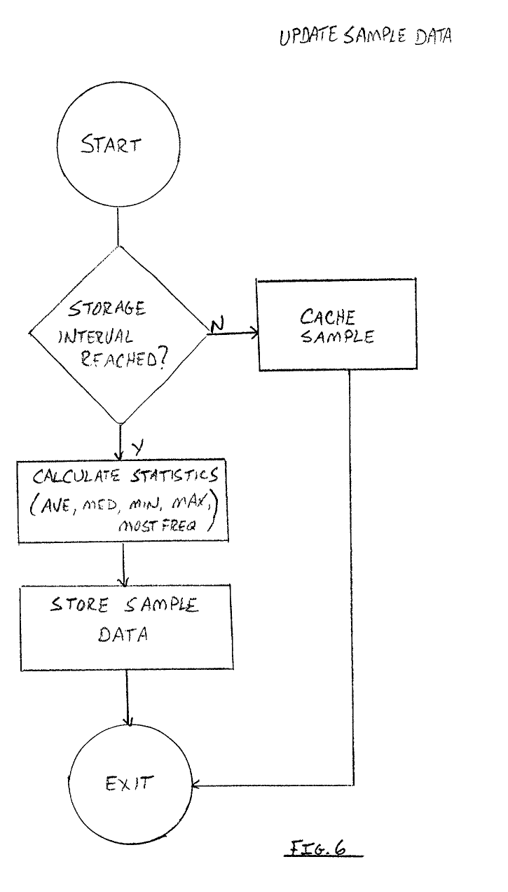

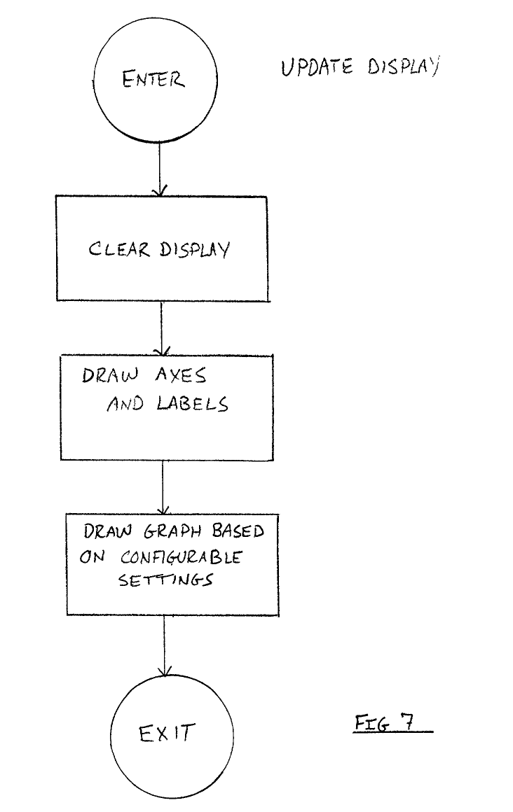

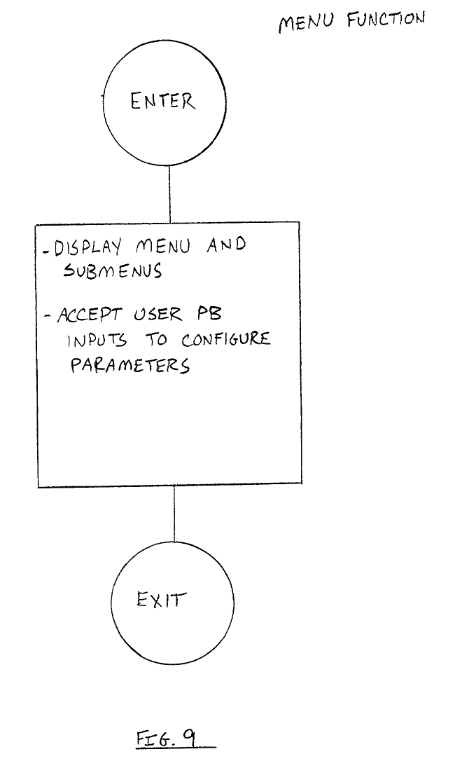

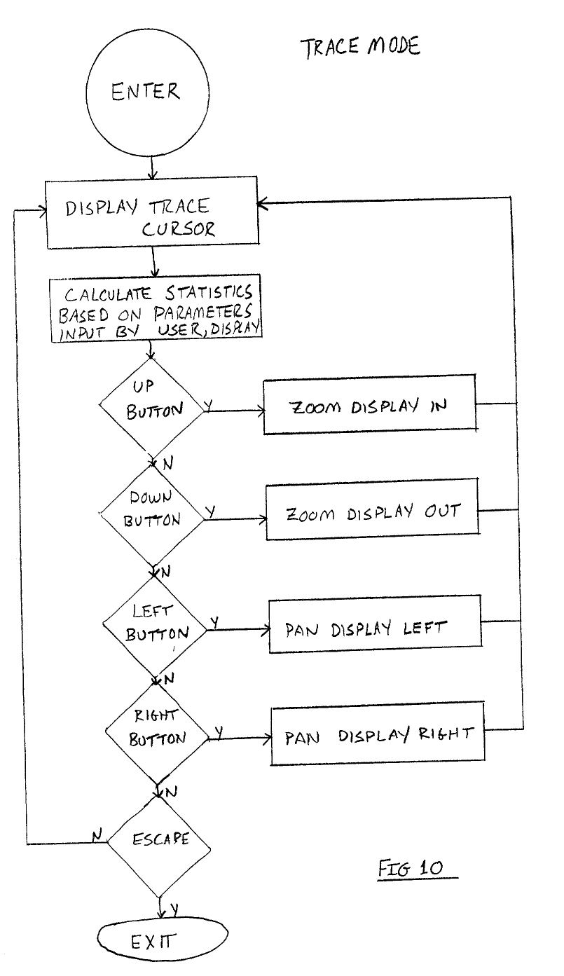

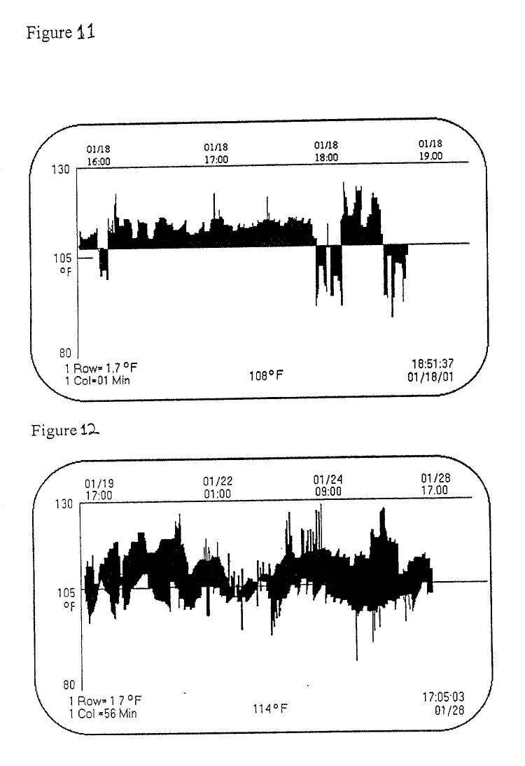

Referring now to FIGS. 3 through 11, the instant invention 10 permits a user to configure a plurality of device parameters to customize the sampling and display of desired data. The parameters are configured using a plurality of user menus which may be viewed on the display by selecting a ‘menu’ push button 40, and then selecting various options using the push buttons 40. User configurable parameters include how often the control unit 20 receives a data sample (sample interval), how often the sampled data is displayed and stored (the display interval), high and low data limits, high and low data alarms, and the time and amplitude scale on the data being displayed. The user may also configure the control unit 20 to calculate a sample average, minimum, maximum, median, and most frequent values prior to storing the samples in memory and displaying them.

The invention 10 is capable of sampling the data provided by the plurality of sensors 120 more often than the data is stored and displayed. A user may configure how the data being sampled is stored and displayed by selecting from a plurality of statistical display options using the push buttons 40 and associated display 60 menus. The data statistics that may be calculated displayed comprise: average, median, most frequent, minimum, and maximum. For example, in an application where each data sample taken is not critical but the user desires to see a long term data trend, the control unit 20 may be configured to display the average or median of every 15 data samples taken. The processor 30 thence calculates an average of 15 data sample values from the sensors 120, then stores the value in memory 34 and sends it to the display 60. Each statistical data calculation is displayed in one display interval or column on the display 60. This process is then reiterated for each subsequent set of samples taken. In contradistinction, in an application where any deviation from a desired data value is critical, the user may configure the control unit 20 to display a maximum (or minimum) value for each set of n samples, such that an operator may quickly determine if a sample is out of range. This feature of the invention 10 provides simple display 60 configuration and great flexibility in a wide variety of device applications.

Once the number of data samples exceeds the displays' 60 ability to provide a graphical representation of all sample data in a given data set, the data samples “pushed off” the display 60 by more recent data may still be accessed by selecting one of the push buttons to scroll back (and forward) through the historical samples. This feature of the invention 10 provides a user nearly instantaneous access to historical data on demand.

Additionally, a user may program alarm conditions that, when satisfied, allow the processor 30 to generate a signal energizing the alarm relay.

As best seen in FIGS. 11 and 12, the instant invention displays the received data (in this example temperature data) graphically on the display 60, the columns of the graph displaying the temperature, and the rows displaying time. The display 60 is programmed to be asleep (blank) until the user selects one of the plurality of buttons 40 on the device. Once a button 40 is selected, the display 60 “wakes up” and displays the programmed graph. After no button 40 has been selected for a predetermined period, the display 60 will go blank again, i.e., the display 60 enters “sleep mode”. While the display 60 is blank the control unit 20 continues to collect data. In an alternative embodiment of the instant invention 10, the display 60 may be configured to provide continuous display. This embodiment is preferred when the device is powered by a permanent power source, rather than battery operation.

In operation, the display 60 is advantageously configured to represent data, for example temperature, using rows and time using columns. A configurable data value scale on the left of the display 60 indicates the selected data (temperature) range.

A system data line at the bottom of the display 60 shows the value of each row. The scale can be changed at any time by configuring the control unit 20 to select a maximum temperature, a minimum temperature and a reference line value. Once the menu mode is exited, the graphical data representation is immediately redrawn to reflect the newly chosen display parameters.

The user may scroll backwards and forwards through the temperature data when the display 60 is configured to be in the “trace” mode. To view more than 180 stored temperatures the user can scroll backwards through the data using the “trace” mode by selecting a “trace” push button 40. A “tracer” arrow appears on the bottom data line on the display 60. The second bottom data line displays the data (temperature) value directly above the “tracer” arrow. Selecting either a right or left arrow push button 40 will cause the “tracer” arrow to move either forward or backward in time. If the left or right margin of the display 60 is exceeded, the data continues to scroll backward or forward as the push buttons 40 are repeatedly pressed.

The foregoing detailed description is given primarily for clearness of understanding and no unnecessary limitations are to be understood therefrom for modifications can be made by those of ordinary skill in the art upon reading this disclosure without departing from the scope of the invention.

I claim:

1. an electronic device for acquiring, storing, and displaying data comprising:
a control unit comprising:
a processor having a read only memory for storing processor instructions, a random access memory for storing data, and having a plurality of data output channels;
a plurality of sensor inputs for accepting data signals;
a plurality of push buttons electrically coupled to the processor for configuring a plurality of user-configurable parameters;
a visual display having an input coupled to a data output channel from the processor for displaying data in a graphical format and operator interface menus;
a speaker electrically connected to the processor alarm output for producing an audible alarm;
a real-time clock for timing intervals between data samples and time-stamping the samples; and
a serial port for transmitting and receiving data to and from a remote device; and
a plurality of data sensors responsive to a measurable variable, said sensors each having an output representative of said physical variable coupled to a one of the sensor inputs of said control unit.

2. An electronic device for acquiring, storing, and displaying data as claimed in claim 1 wherein said user-configurable parameters include data sampling intervals, display ranges, high and low alarm values, display intervals, and sensor types.

3. An electronic device for acquiring, storing, and displaying data as claimed in claim 1 wherein said control unit further comprises at least one alarm output for triggering a remote alarm.

4. An electronic device for acquiring, storing, and displaying data as claimed in claim 3 wherein said alarm output is activated responsive to at least one user-configured alarm value.

5. An electronic device for acquiring, storing, and displaying data as claimed in claim 1 wherein said control unit further comprises a power management system whereupon operating power is supplied to said plurality of sensors only at predetermined data sampling intervals.

6. An electronic device for acquiring, storing and displaying data as claimed in claim 1 wherein the visual display is capable of displaying historical data supplied by said plurality of data sensors responsive to a push button being selected.

7. An electronic device for acquiring, storing and displaying data as claimed in claim 1 wherein said control unit further comprises an output port for transmitting and receiving data to and from a remote device.

8. An electronic device for acquiring, storing and displaying data as claimed in claim 1 wherein the display graphically represents a plurality of data values in each display column.

9. An electronic device for acquiring, storing and displaying data as claimed in claim 1 wherein the display graphically represents data supplied by any one of said plurality of data sensors responsive to a push button selection.

10. An electronic device for acquiring, storing and displaying data as claimed in claim 1 wherein the display graphically represents a statistical value of a plurality of data samples taken from said plurality of sensors in each display interval.

11. An electronic device for acquiring, storing, and displaying data comprising:
a control unit comprising:
a processor having a read only memory for storing processor instructions, a random access memory for storing data, and having a plurality of data output channels;
a plurality of sensor inputs for accepting data signals;
a plurality of push buttons electrically coupled to the processor for configuring a plurality of user-configurable parameters;
a visual display having a plurality of data inputs coupled to the plurality of data output channels from the processor for displaying a plurality of data sets in a graphical format, the data set displayed being responsive to a push button selection;
a speaker electrically connected to the processor alarm output for producing an audible alarm;
a real-time clock for timing intervals between data samples and time-stamping the samples; and
a serial port for transmitting and receiving data to and from a remote device; and
a plurality of data sensors responsive to a measurable variable, said sensors each having an output representative of said physical variable coupled to a one of the sensor inputs of said control unit.

12. An electronic device for acquiring, storing, and displaying data as claimed in claim 10 wherein said user-configurable parameters include data sampling intervals, display ranges, high and low alarm values, display intervals, and sensor types.

13. An electronic device for acquiring, storing, and displaying data as claimed in claim 10 wherein said control unit further comprises at least one alarm output for triggering a remote alarm.

14. An electronic device for acquiring, storing, and displaying data as claimed in claim 12 wherein said alarm output is activated responsive to at least one user-configured alarm value.

15. An electronic device for acquiring, storing, and displaying data as claimed in claim 10 wherein said control unit further comprises a power management system whereupon operating power is supplied to said plurality of sensors only at predetermined data sampling intervals.

16. An electronic device for acquiring, storing and displaying data as claimed in claim 10 wherein the visual display is capable of displaying historical data supplied by said plurality of data sensors responsive to a push button being selected.

17. An electronic device for acquiring, storing and displaying data as claimed in claim 10 wherein said control unit further comprises an output port for transmitting and receiving data to and from a remote device.

18. An electronic device for acquiring, storing and displaying data as claimed in claim 10 wherein the display graphically represents a plurality of data values in each display column.

19. An electronic device for acquiring, storing and displaying data as claimed in claim 10 wherein the display graphically represents data supplied by any one of said plurality of data sensors responsive to a push button selection.

20. An electronic device for acquiring, storing and displaying data as claimed in claim 11 wherein the display graphically represents a statistical value of a plurality of data samples taken from said plurality of sensors in each display interval.
